(19) United States
(12) Patent Application Publication
(10) Pub. No.: US 2025/0248545 A1
(43) Pub. Date: Aug. 7, 2025

(54) METHOD AND ASSEMBLY FOR DISPLAYING AND SECURING A WEARABLE DEVICE AGAINST THEFT

(71) Applicant: SE-KURE CONTROLS, INC., Franklin Park, IL (US)

(72) Inventors: David M. Adams, Stone Park, IL (US); John W. Manser, Elgin, IL (US)

(21) Appl. No.: 19/044,281

(22) Filed: Feb. 3, 2025

Related U.S. Application Data
(60) Provisional application No. 63/550,431, filed on Feb. 6, 2024.

(51) Int. Cl. A47F 7/024; A47F 7/02; H04M 1/02; H04M 1/04

(52) U.S. Cl. CPC A47F 7/024; A47F 7/022; H04M 1/0203; H04M 1/04

(57) ABSTRACT

A method, and security assembly, for displaying a wearable device having a case and a band. The security assembly is changeable between first and second states and has a frame on which a case on the wearable device can be placed in a display position. With the security assembly in the first state, the case can be: a) moved from a spaced position consistently into the display position; and b) moved out of the display position. With the security system in the second state, the case is prevented from being moved out of the display position.

### CROSS-REFERENCE TO RELATED APPLICATIONS

This is a non-provisional application claiming priority to U.S. Provisional Application No. 63/550,431, filed Feb. 6, 2024, which is incorporated herein by reference.

### BACKGROUND OF THE INVENTION

### Field of the Invention

This invention relates to wearable devices, such as but not limited to, smart watches and, more particularly, to a method and apparatus for displaying such wearable devices, as at a point of purchase, and securing them against theft.

### Background Art

For decades, manufacturers of watches have displayed their products in retail establishments in a manner that they can be readily observed, handled, and ofttimes worn. These “hands-on” displays are desirable given the competitive nature of this industry which offers a multitude of different products from several foreign and domestic suppliers. To give potential purchasers an opportunity to make an informed decision, displays will commonly have many different products from many different manufacturers displayed for viewing at the same time, with these products having a wide range of features, appearances, and price ranges.

Given the desirability of making many different products available for viewing, to this day watch products are often displayed in secured glass cases monitored by one or more salespersons. When someone is interested in physically handling one of the watches, the overseer unlocks the case and offers the requested watch(es) for inspection.

This well-known manner of displaying watches still remains viable primarily because it offers the flexibility of displaying at the same time a large number of different products, viewable through glass, in a relatively compact space, with at least some level of security.

The primary drawbacks with the conventional cases are that: a) the individual watches when being handled by a prospective purchaser are untethered; and b) salespersons are challenged, particularly in high-volume operations, to keep track of watches that may be made available to multiple different persons simultaneously during busy times.

Still further, theft through “smash and grab” activities is increasing since these cases are generally constructed using glass panels that shatter when impacted as by a brick, hammer, etc.

As a result of at least the above limitations, theft of watches over the years has been substantial. Special measures are often taken to handle very high-end watches but in spite of this, untethered watches remain vulnerable to theft.

The assignee herein has developed display stands upon which watches can be individually secured and monitored. One exemplary form is disclosed in U.S. Pat. No. 10,274,898.

Within the broad category of watches and wearable devices is the smart watch, which has evolved to have potentially a wide range of capabilities, with these capabilities expanding continuously. These smart watches, which in many respects were originally designed as smartphone accessories, now have additional capabilities comparable to those which, until recently, were achievable only by dedicated and expensive electronic equipment.

Designers of smart watches generally strive to increase capabilities while at the same time minimizing the size of the smart watch. Many large tech companies are competing in the smart watch industry. While this competition has resulted in the ongoing development of even further capabilities of the smart watches, the cost of the high-end smart watches continues to rise.

Due to their ever increasing value and compact nature, smart watches are more and more becoming the targets of thieves. Thus, retailers have been challenged to devise display systems that allow prospective purchasers to inspect a large number of products, made by different manufacturers and with different capabilities and sophistication, adequately to make an informed decision, while at the same time controlling product loss.

While it is possible to offer display structures that will accommodate individual watches, allowing them to be closely inspected and securely maintained against movement away from a display location, sellers are always challenged with balancing loss due to theft and investment in security systems which oftentimes are best suited for one or only a limited number of products.

As smart watch technology continues to evolve and more versions become available, retail sales facilities will be continuously challenged to offer potential purchasers meaningful inspection of many different smart watches adequately that a sale may result, while minimizing risk of loss that increases as more “hands on” inspection of products is permitted.

### SUMMARY OF THE INVENTION

In one form, the invention is directed to the combination of: a) a first wearable device having a first case containing operating components and a first band connected to the case and configured to extend at least partially around a limb of a user to maintain the first wearable device operatively supported on the user's limb; and b) a security assembly on which the first wearable device can be displayed and confined in movement away from a main support. The security assembly has a frame on which the first case can be placed in a display position. The security assembly is configured to be changeable between first and second states. The security assembly in the first state is configured to allow the first case to be selectively moved: i) from a first position spaced from the frame consistently into the display position; and ii) from the display position away from the frame. The security assembly in the second state is configured to prevent the first case in the display position from being separated from the security assembly.

In one form, the security assembly has spaced first and second receptacles into which spaced first and second parts of the first case project with the first case in the display position and the security assembly in the second state.

In one form, with the security assembly in the second state, the first and second receptacles open towards each other.

In one form, the security assembly has a holding part that is movable between first and second positions. One of the first and second receptacles is defined at least partially on the holding part. The security assembly is changed from the first state into the second state as an incident of the holding part moving from the first position into the second position.

In one form, the first receptacle is defined at least partially by a first wall on the frame.

In one form, the second receptacle is defined at least partially by a second wall on the holding part.

In one form, at least one of the first and second walls has one opening in communication with a respective wall receptacle through which a part of the first band projecting away from the first case extends with the first case in the display position and the security assembly in the second state.

In one form, the holding part is pivotable relative to the frame around a first axis in moving between the first and second positions for the holding part.

In one form, the holding part is spring biased towards the first position for the holding part.

In one form, the first wearable device is a chargeable device. The frame has a support surface against which the first case abuts with the first case in the display position. An opening is defined through the support surface. The invention is provided in further combination with a charger for the chargeable device that is supported on the frame, exposed through the support surface opening, and operable to charge the first wearable device with the first case in the display position.

In one form, the frame has a pedestal that is configured to be fixed to the main support whereupon the support surface is maintained in an elevated position above the main support.

In one form, the charger has a power cord that is directed through the pedestal.

In one form, there is a component on the frame that cooperates with a component on the holding part to releasably maintain the holding part in the second position.

In one form, the component on one of the frame and holding part is a post and the component on the other of the frame and holding part is a receptacle for the post. The post projects into the receptacle to thereby maintain the holding part in the second position.

In one form, the security assembly further includes a lock that is changeable between locked and unlocked states. The lock in the locked state prevents the post from being withdrawn from the receptacle. The lock in the unlocked state allows the post to be withdrawn from the receptacle.

In one form, the combination described above is provided in combination with an actuator that is separate from the lock and usable to change the lock from the locked state into the unlocked state.

In one form, the frame has a first edge facing in one axial direction with respect to the first axis. The holding part has a first edge facing oppositely to the one axial direction and in confronting relationship with the first edge on the frame with the holding part in the second position.

In one form, the frame has a second edge and the holding part has a second edge. The second edge on the holding part and the second edge on the frame face axially oppositely with respect to the first axis and are in confronting relationship with the holding part in the second position.

In one form, the receptacle defined at least partially by one of the first and second walls has a first configuration. The security assembly further includes a first adaptor that is usable in conjunction with the one of the first and second walls to change the first receptacle configuration to a second receptacle configuration.

In one form, the first adaptor is configured to be placeable in an operative position to change the receptacle defined at least partially by the one of the first and second walls from the first receptacle configuration to the second receptacle configuration. With the first adaptor in the operative position and the first case in the display position, the first adaptor is blocked in the operative position.

In one form, the combinations described above are provided in further combination with a second wearable device having a second case containing operating components and a second band configured to extend at least partially around a limb of a user to maintain the second wearable device operatively supported on the user's limb. The second case has a configuration different than a configuration of the first case. The receptacle defined at least partially by the one of the first and second walls with the first configuration is adapted to receive a part of the first case. The receptacle defined at least partially by the one of the first and second walls with the second configuration is adapted to receive a part of the second case.

In one form, the first and second wearable devices each is a smartphone.

In one form, the frame has a mounting base that is fixed to the pedestal and configured to be placed against and fixed relative to a flat surface on the main support.

In one form, the combinations described above are provided in further combination with the main support with the flat surface against which the mounting base is fixed.

In one form, the charger has a power cord. The pedestal has a peripheral surface through which the power cord for the charger extends to allow access to the power cord above the flat surface of the main support.

In one form, the charger has a power cord that is directed through the pedestal and the flat surface on the main support.

In one form, the invention is directed to a method of displaying a wearable device. The method includes the steps of: obtaining a first wearable device having a first case containing operating components and a first band configured to extend at least partially around a limb of a user to maintain the first wearable device operatively supported on the user's limb; obtaining a security assembly having a frame and a holding part, the security assembly configured to be changeable between first and second states; placing the frame on a main support; with the security assembly in the first state, placing the case against the frame and causing a first part of the case to move within a first receptacle on the frame whereupon the case is in a display position on the frame; and changing the holding part from a first position into a second position to thereby change the security assembly from the first state into the second state and cause a second part of the case to be moved within a second receptacle on the holding part. The first case is captively held between the frame and the holding part with the first case in the display position and the holding part in the second position.

In one form, the holding part is pivoted relative to the frame in moving between the first and second positions for the holding part.

In one form, the method further includes the step of directing a first part of the first band extending away from the first case through a fully surrounded first opening on one of the frame and the holding part.

In one form, the method further includes the step of directing a second part of the first band extending away from the first case through a fully surrounded second opening on the other of the frame and the holding part.

In one form, the first wearable device is a chargeable wearable device. The method further includes the step of placing a charger on the frame so that with the first case in the display position the charger is operable to charge the first wearable device.

In one form, the method further includes the steps of obtaining an adaptor, and placing the adaptor in an operative position on one of the frame and holding part to change the receptacle on the one of the frame and holding part from a first configuration to a different second configuration.

In one form, the method further includes the steps of: a) obtaining a second wearable device having a second case containing operating components and a second band configured to extend at least partially around a limb of a user to maintain the second wearable device operatively supported on the user's limb; and b) with the adaptor in the operative position and the case in the display position, changing the holding part from the first position into the second position. The second case has a configuration different than a configuration of the first case.

In one form, the method further includes the step of releasably locking the holding part in the second position.

In one form, the frame has a pedestal. The method further includes the step of fixing the pedestal to a surface on the main support so that the first case in the display position is spaced above the surface on the main support.

In one form, the first wearable device is a chargeable device. The method further includes the step of placing a charger on the frame so that with the first case in the display position the charger is operable to charge the wearable device.

In one form, the method further includes the step of directing a power cable for the charger through the pedestal.

In one form, the method further includes the step of directing a power cord for the charger from the charger into the pedestal.

In one form, the method further includes the step of directing a power cord for the charger from the charger into the pedestal and through a peripheral wall of the pedestal above the surface on the main support.

In one form, the method further includes the step of directing a power cord for the charger from the charger through the pedestal and through the surface of the main support.

### BRIEF DESCRIPTION OF THE DRAWINGS

FIG. 1 is a schematic representation of a wearable device that can be displayed and secured according to the present invention;

FIG. 2 is a schematic representation of one form of security assembly, according to the present invention, for displaying and securing a wearable device, as in FIG. 1, relative to a main support;

FIG. 3 is a schematic representation of a frame and holding part making up part of one form of the security assembly in FIG. 2;

FIG. 4 is a schematic representation showing additional details of a wall on at least one of the frame and holding part in FIG. 3;

FIG. 5 is a schematic representation showing components cooperating between the frame and holding parts as shown in FIG. 3;

FIG. 6 is a schematic representation showing interactive edges/surfaces on the frame and holding part as shown in FIGS. 3 and 5;

FIG. 7 is a schematic representation of an adaptor utilized on one or both of the frame and holding part to accommodate a different configuration of wearable device;

FIG. 8 is a partially schematic, perspective view of one form of the security assembly as shown schematically in FIGS. 1-7, with one form of wearable device having a case in a display position and a holding part in a position wherein the security assembly is in a state to maintain the case in the display position;

FIG. 9 is an exploded perspective view of the components in FIG. 8;

FIG. 10 is a perspective view of one form of charger for the wearable device in FIGS. 8 and 9 that can be incorporated into the security assembly;

FIG. 11 is a view of the support assembly from the FIG. 8 perspective, with a part partially broken away, with the wearable device separated, with the holding part in a different position than in FIG. 8, and with an adaptor usable to accommodate a different form of a case on a wearable device;

FIG. 12 is a front elevation view of the components in the FIG. 8 state;

FIG. 13 is a cross-sectional view of the components taken along line 13-13 of FIG. 12;

FIG. 14 is a side elevation view of the components in the FIG. 8 state, with the holding part shown moved to a different position in dotted lines;

FIG. 15 is a rear elevation view of the components in the FIG. 8 state;

FIG. 16 is a cross-sectional view of the components taken along line 16-16 of FIG. 15;

FIG. 17 is a cross-sectional view of the components taken along line 17-17 of FIG. 12 and with the holding part shown in the dotted line position of FIG. 14;

FIG. 18 is a top perspective view of the components in the FIG. 11 state;

FIG. 19 is a perspective view of one of the parts on the frame on the security assembly in FIGS. 8-18;

FIG. 20 is an exploded perspective view of the holding part on the security assembly in FIGS. 8-18;

FIG. 21 is a perspective view of a modified form of the wall/adaptor as shown in FIG. 11;

FIGS. 22 and 23 are fragmentary views sequentially showing connection of the adaptor in FIG. 21 to one of the frame or holding part on the inventive security assembly;

FIG. 24 is a flow diagram representation of a method for displaying and securing a wearable device according to the present invention; and

FIG. 25 is a flow diagram representation of additional method steps performed according to the present invention.

### DETAILED DESCRIPTION OF THE PREFERRED EMBODIMENT

The present invention is directed to a method and apparatus for displaying and securing a wearable device of the type shown schematically at 10 in FIG. 1. The wearable device 10 consists of a case 12 containing operating components 14. A band 16 connected to the case 12 is configured to extend at least partially around a limb of a user to maintain the wearable device operatively supported on the user's limb.

The wearable device 10 is depicted schematically in FIG. 1 to encompass virtually an unlimited number of different forms thereof. What is common to each device is that it has a case 12 that is substantially shape-retentive to house the operating components 14, that may be mechanical and/or electronic in nature. As just examples, and without limitation, the wearable device 10 may be a mechanical watch or a smart watch.

Likewise, the nature of the band 16 is not limited, as it may have any well-known configuration, such as ones utilizing separate strap parts, joinable strap parts, etc.

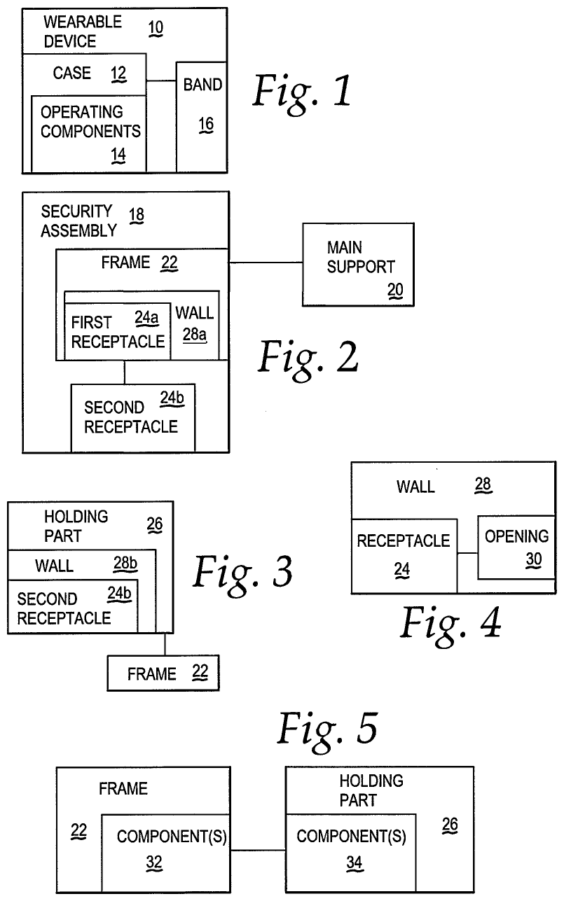

As shown in FIG. 2, a security assembly 18 is provided on which the wearable device 10 can be displayed and confined in movement away from a main support 20 upon which the security assembly 18 is placed. The security assembly 18 may be fixed to the main support 20 or otherwise interconnected therewith so as to confine movement of the displayed wearable device 10 away from the main support 20.

The security assembly 18 has a frame 22 on which the case 12 can be placed with the case in a display position.

The security assembly 18 is configured to be changeable between first and second states. In the first state, which may be established within a range, the security assembly 18 is configured to allow the case 12 to be selectively moved: a) from a first position spaced from the frame 22 into the display position; and b) from the display position away from the frame 22.

The security assembly 18 is configured so that in its second state, which again may be established within a range, it prevents the case 12 in the display position from being separated from the security assembly 18.

As shown in FIG. 2, the security assembly 18 has spaced first and second receptacles 24a, 24b into which spaced first and second parts of the case 12 respectively project with the case 12 in the display position and the security assembly in the second state. This produces a captive arrangement for at least one dimension of the case 12.

In one form, with the security assembly 18 in the second state, the first and second receptacles 24a, 24b open towards each other.

As depicted in FIG. 3, the security assembly 18 has a holding part 26 that is movable relative to the frame 22 between first and second positions. In this form, one of the receptacles 24, and in this case the second receptacle 24b, is defined at least partially on the holding part 26, with the security assembly 18 changed from the aforementioned first state into the second state as an incident of the holding part 26 moving from the first position into the second position therefor.

Generally, the first state for the security assembly 18 exists with the holding part 26 in its first position, with the second state resulting from the holding part 26 moving from its first position into its second position. That is, the security assembly 18 is changed from its first state into its second state as an incident of the holding part 26 moving from its first position into its second position.

As seen in FIG. 2, the first receptacle 24a may be defined at least partially by a first wall 28a on the frame 22, with the second receptacle 24b defined at least partially by a second wall 28b on the holding part 26, as seen in FIG. 3.

As explained below, part or all of each or both of the walls 28a, 28b may be: a) integrally formed with its respective part-frame 22 and holding part 26; and b) or separately attached to its respective part.

It should be emphasized that the designations “first” and “second” are arbitrary and used interchangeably in both the description and claims herein and should not be viewed as limiting.

As shown in FIG. 4, one or both of the walls 28 has an opening 30 in communication with a respective receptacle 24 through which a part of the band 16, projecting away from the case 12, extends with the case 12 in the display position and the security assembly 18 in the second state.

As shown in FIG. 5, the frame 22 has at least one component 32 that cooperates with at least one component 34 on the holding part 26 to releasably maintain the holding part in the second position therefor.

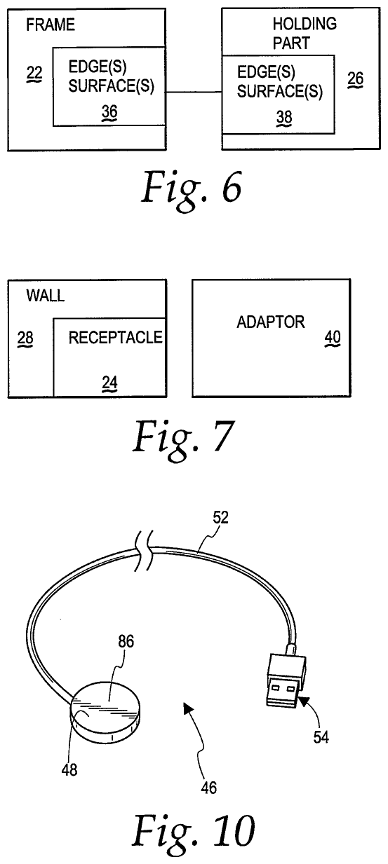

As shown in FIG. 6, in one form, the holding part 26 is movable relative to the frame 22, without limitation, as by pivoting around an axis, in moving between its first and second positions. With the holding part 26 pivoted to its second position, at least one axially spacing edge/surface 36 on the frame 22 is in confronting relationship with an axially oppositely facing edge/surface 38 on the holding part 26 to prevent wedging of the frame 22 and holding part 26 axially away from each other as by a would-be thief.

A plurality of confronting edges/surfaces 36, 38 may be provided for further security and rigidity of construction.

As shown in FIG. 7, an adaptor 40 may be provided to cooperate with one or both of the walls 28 to change the configuration of its respective receptacle 24 to be more dimensionally or shape compatible with a different configuration of the case 12. The adaptor 40 can be releasably connected to its respective wall 28 or may be press fit so as to be effectively inseparable therefrom. In the former case, the configuration of the security assembly 18 can be changed back and forth to accommodate different models of wearable device. For example, smart watch manufacturers offer different models that have different case configurations in terms of shape and size. The adaptors 40 can be provided individually or in pairs to convert the security assembly 18 to handle different models.

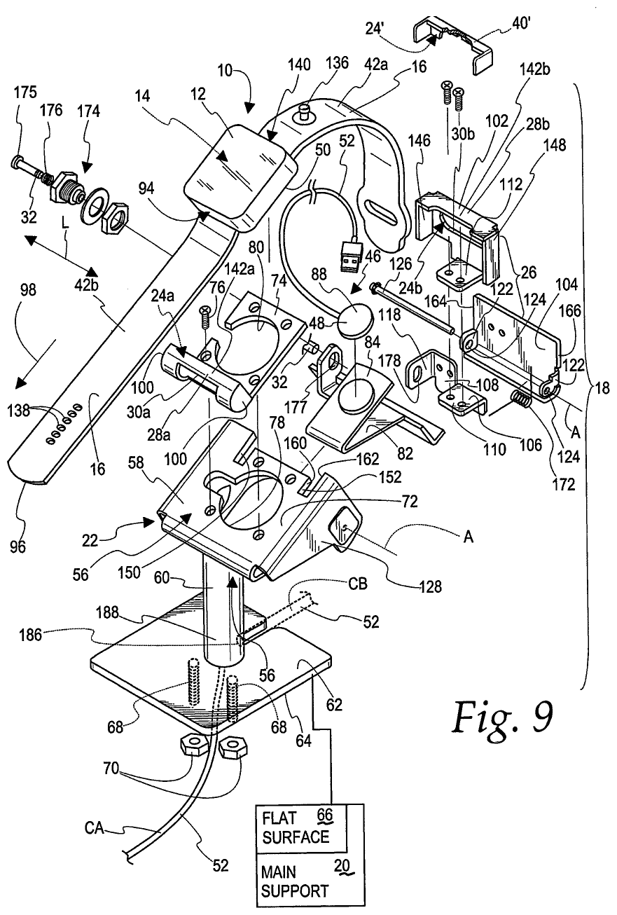

The adaptor may be alternatively configured and connected, with alternative exemplary forms shown in FIGS. 9 and 11 and 21-23 and described hereinbelow.

It should be understood that the schematic depiction of components is intended to encompass virtually an unlimited number of variations of each component as well as their interactions. The specific forms of the invention, as described hereinbelow, which come within the schematic representation in FIGS. 1-7, are exemplary in nature only.

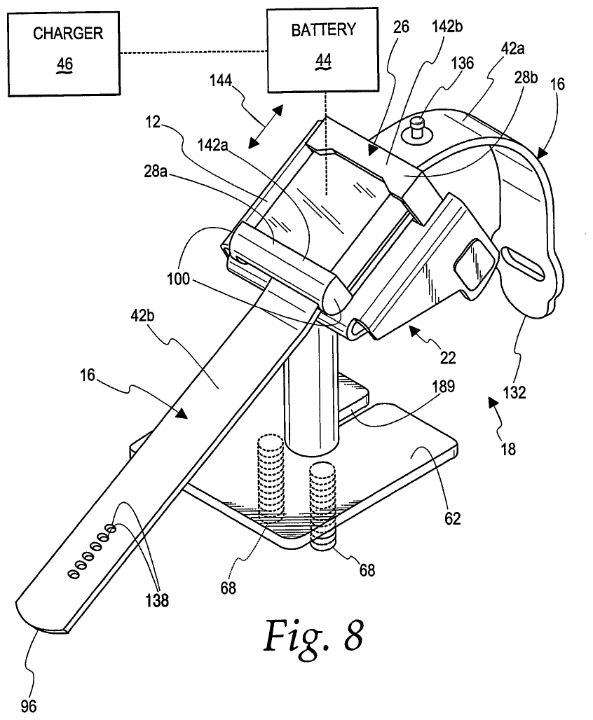

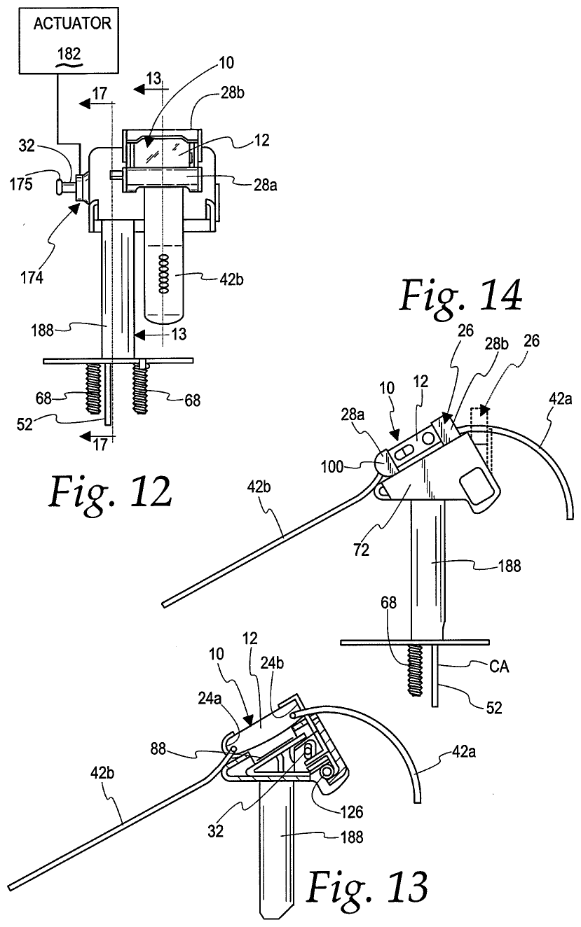

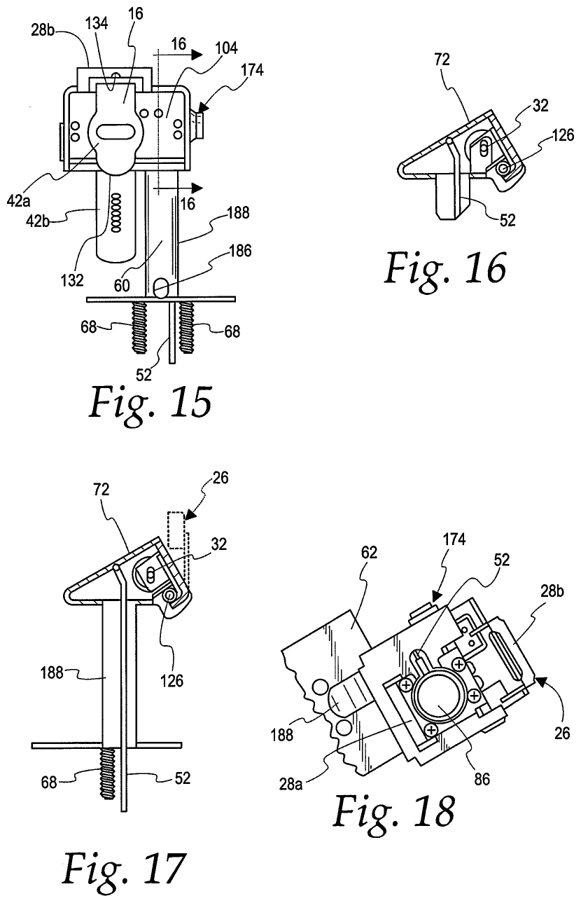

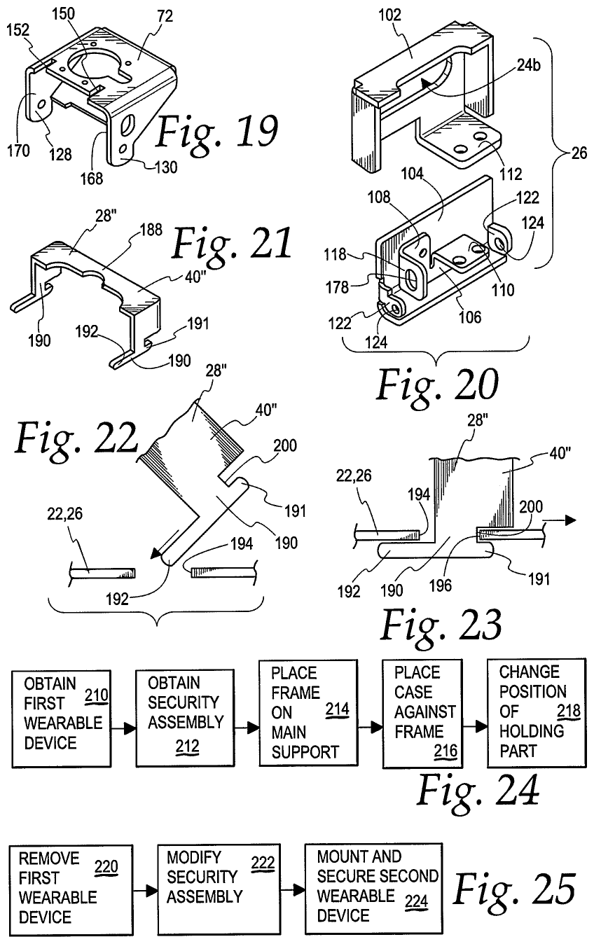

Referring now to FIGS. 8-23, the general shape of the depicted wearable device 10 is intended to be a generic representation of smart watches, each having a case 12 from which strap parts 42a, 42b, cooperatively making up the aforementioned band 16, project.

The case 12 houses the operating components 14, the details of which are not critical to the present invention. While the wearable device 10 is not required to be rechargeable, in the depicted form, a battery 44 is one of the operating components 14 and is rechargeable by a charger depicted schematically at 46 in FIG. 8 and in one exemplary form in FIGS. 9 and 10. The details of the charger 46 are not critical to the present invention.

In one exemplary form, as used by at least one current smartphone manufacturer, the charger 46, as shown in FIGS. 9 and 10, utilizes inductive technology with charging effected through a sealed disc-shaped housing 48 placed in proximity to the back 50 of the case 12 without requiring direct contact therewith. A power cord 52 extends from the housing 48 and has a conventional male USB connector 54 at its free end.

The frame 22 consists of a main base part 56 consisting of a downwardly opening U-shaped support piece 58 with a tubular pedestal 60 fixed thereto with the pedestal 60 in turn fixed to a flat mounting base 62 with an underside 64 placed against a flat surface 66 of the main support 20, which may be a countertop or any other structure relative to which the frame 22 is either fixed or confined at setup.

The pedestal 60 is off-center left of the main base part 56, from the FIG. 9 perspective, for reasons explained further below.

In this embodiment, cantilevered threaded shafts 68 project downwardly from the mounting base 62 and are extendable through a thickness of the main support 20 which can be captively engaged between the underside 64 and in this case nuts 70, threaded one each to the shaft 68.

The support piece 58 has an angularly situated wall part 72 with a surface against which the back 50 of the case 12 can be placed with the case in the display position, as shown in FIG. 1, to optimize viewing perspective.

As depicted, a separate piece 74 is attached to the wall part 72 through fasteners 76 (one shown) and by itself or in conjunction with the wall part 72, defines a surface that directly contacts and supports the back 50 of the case 12. The particular supporting interaction depends upon the configuration of the back 50 of the particular device 10.

In the depicted form, a keyhole shape cutout 78 is provided through the wall part 72, with the piece 74 having a substantially matching cutout 80.

A battery support 82 is fixed to the wall part 72 so that a cantilevered flat piece 84 thereon resides beneath the registered cutouts 78, 80 and is spaced below the wall part 72 so that with the charger housing 48 placed thereon, the upper surface 86 of the housing 48 is in relationship to the back 50 of the case 12 to effect preferably optimal charging of the device 10 with the case 12 in its display position.

In the depicted form, as seen in FIG. 10, a double-sided adhesive pad 88 may be adhered to the flat piece 84. By peeling a protective layer 90, a surface 92 with adhesive is exposed, thereby allowing the housing 48 to be pressed thereagainst and maintained in the operative position, as seen most clearly in FIG. 13.

The piece 74 has the wall 28a thereon that defines the first receptacle 24a into which one part 94 of the case 12 can be directed. The wall 28a has the opening 30a through which the free end 96 of the strap part 42b can be directed and drawn through in the direction of the arrow 98 in FIG. 9 until the case part 94 moves into the receptacle 24a.

The exact relationship between the case part 94 and receptacle 24a is not limited. The opening 30a is shown as a fully surrounded opening whereby the shifting of the case part 94 in a lateral direction, as indicated by the double-headed arrow L, may be limited by the interaction of the strap part 42b with the wall 28a. As depicted, the case part 94 fits into the receptacle 24a so that the case part 94 is confined laterally by spaced stop parts 100 that bound the receptacle 24a.

With the depicted configuration, directing the case part 94 into the receptacle 24a causes the case 12 to consistently assume a predetermined, desired display position.

In this embodiment, the holding part 26 is made of multiple pieces, though this is not a requirement. As depicted, a first piece 102 defines a part of the receptacle 24b and is integrated into a main wall piece 104 through an intermediate bracket 106 that has a main portion 108, fixed to the wall piece 104, with a cantilevered leg 110 joined to a tab 112 on the first piece 102 projecting angularly in cantilever fashion from the piece 102.

The bracket 106 has an additional cantilevered leg 118 defining the aforementioned component 34, as shown in FIG. 5 and described in detail below.

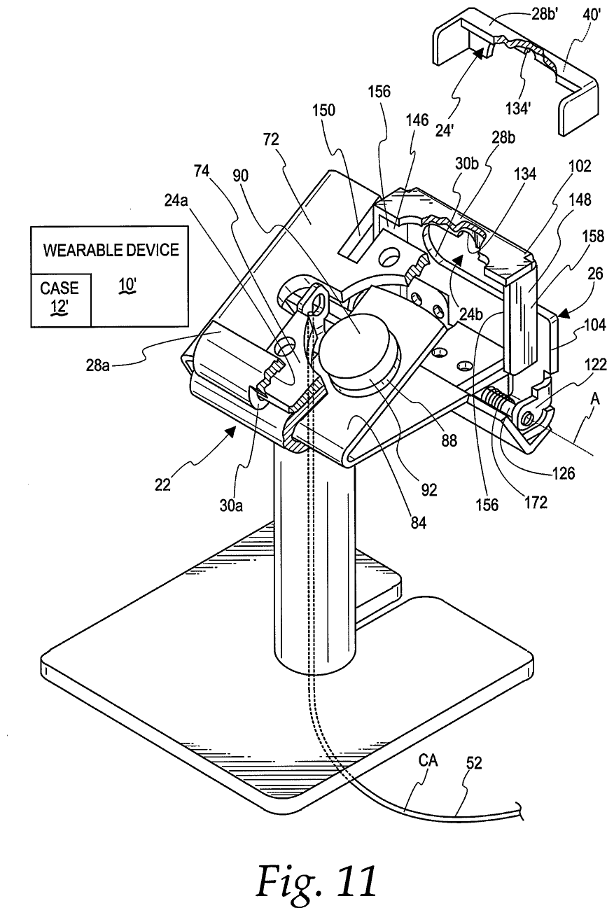

The wall piece 104 has spaced, outturned tabs 122, each with a throughbore 124 to accept a spanning pivot pin 126. The pivot pin 126 also spans depending legs 128, 130 on the wall part 72 and supports the holding part 26 for pivoting movement about an axis A between: a) its first position, as shown in dotted lines in FIGS. 14 and 17 and in solid lines in FIG. 11; and b) its second position, as seen clearly in FIGS. 8 and 13.

With the holding part 26 in its first position, the free end 132 of the strap part 42a can be directed through the laterally elongate, fully surrounded opening 30b on the wall 28b on the holding part 26, that defines part of the receptacle 24b; first passing through the receptacle 24a that is in communication with the opening 30b. A discrete cutout 134 through the wall 28b accommodates a stud 136 on the strap part 42a that is selectively press fit into one of the openings 138 on the strap part 42b to maintain a selected effective diameter of a closed loop defined by the case 12 and joined strap parts 42a, 42b.

In this embodiment, the receptacle 24b is defined cooperatively by the wall 28b and the piece 74 against which the back 50 of the case 12 bears with the case 12 in the display position.

A part 140 of the case 12 opposite to the part 94 cooperates with the receptacle 24b in substantially the same manner that the part 94 of the case 12 cooperates with the receptacle 24a, as described above. With the holding part 26 in its first position, the strap parts 42a, 42b can be directed into and drawn through their respective openings 30a, 30b. The strap part 42b is initially drawn through the opening 30a adequately to consistently seat the case part 94 in the receptacle 24a.

Once this occurs, the drawing of the strap part 42a through the opening 30b and pivoting of the holding part 26 from its first position into its second position is coordinated so that the case part 140 can be directed into the receptacle 24b without interference from the strap part 42a.

At this point, free end portions 142a, 142b on the walls 28a, 28b respectively overlie the case parts 94, 140 to thereby block the case from being drawn away from the frame 22 and out of its display position. The case 12 is further captive between the walls 28a, 28b against shifting in a fore-and-aft direction, as indicated by the double-headed arrow 144.

As depicted, with the holding part 26 in its second position, the receptacles 24a, 24b open towards each other.

The wall 28b has laterally spaced wall parts 146, 148 which respectively move into blind slots 150, 152 formed on the wall part 72. As this occurs, on the exemplary wall part 148, axially oppositely facing surfaces/edges 156, 158 are placed in confronting relationship with axially oppositely facing surfaces 160, 162, respectively.

Corresponding surface/edge interaction occurs between the wall part 146 and the slot 150.

Still further, axially oppositely facing surfaces/edges 164, 166 respectively confront surfaces/edges 168, 170 on the wall part 72.

The pairs of axially confronting surfaces/edges improve structural integrity by resisting prying of the holding part 26 away from the frame 22 by a would-be thief.

One form of the aforementioned adaptor 40 is shown at 40′ in FIG. 11. The adaptor 40′ defines a receptacle 24′ corresponding to the aforementioned receptacles 24a, 24b. The adaptor 40′, as shown in FIG. 11, can be press fit into an operative position within the receptacle 24b to thereby change the configuration and/or dimension of the receptacle 24b to accommodate a different shape or size of case 12. The adaptor 40′ has a wall 28b′ that cooperates with a different form of case part 140 the same way as the wall 28b cooperates therewith and is open with a discrete cutout 134′, in registration with the cutout 134, to allow passage therethrough of the band part 42a.

The use of the adaptor 40′ allows the security assembly 18 to accommodate a wearable device 10′, as shown schematically in FIG. 11 and having a different configuration than the wearable device 10, with this adaptation permitted without requiring use of any separate tools. That is, the adaptor 40′ will be captured in place by the case 12′ with the case 12′ in the display position and the holding part 26 in its second position.

A suitable adaptor 40′ can be used with either or both of the walls 28a, 28b, with multiple different interchangeable adaptors contemplated.

A torsion spring 172 surrounds the post 126 and is loaded to bias the holding part 26 in pivoting movement around the axis A towards the second position for the holding part 26. With no wearable device 10 being displayed, the first state for the security assembly 18, with the holding part 26 in the first position therefor, is normally assumed, as seen in FIG. 8, for convenience of use.

A push button type lock 174 is mounted on the wall part 72 and has the aforementioned component 32, as shown in FIG. 5, which is in the form of an extendable post 32. The post 32 is normally spring-biased into an unlocked position. By pressing a head 175 on one end of the post 32 against the force of a biasing spring 176, the opposite free end of the post 32 can be advanced through a bore/receptacle 177 in the battery support 82 and an aligned bore/receptacle 178 in the holding part 26, with the bore 178 corresponding to the component 34 as shown schematically in FIG. 5. The post 32, extended with the lock 174 in a locked state, blocks pivoting movement of the holding part 26 out of its second position and back into its first position.

The lock 174 can be changed from its unlocked state into its locked state by simply pressing the post 32.

When it is desired to change the lock 174 back into its unlocked state, an actuator 182, as in the form of a specially adapted key, is used. Alternatively, other conventional type locks and actuators, including those using electronic control, may be utilized.

The above described arrangement allows the user to efficiently place the wearable device 10 consistently in the display position, change the security assembly 18 from its first state into its second state, and effect locking thereof without requiring any separate tools.

A further aspect of the invention is that the power cord 52 can be routed into the pedestal 60 through the cutouts 78, 80 either fully therethrough and part of the main support 20 to effect connection “under counter”, as shown at CA in FIGS. 9 and 11, or through an opening 186 in the peripheral wall 188 of the pedestal 60, as shown at CB in FIG. 9, to allow connection above the flat surface 66 on the main support 20. The off center connection of the pedestal 60 and support piece 58 facilitates this cable routing. A slot 189 is formed in the mounting base 62 so that the power cord 52 projecting from the opening 186 can be nested therein to be flush or nearly flush with the top of the mounting base 62.

In FIGS. 21-23, an alternative configuration for an adaptor 40″, corresponding to the adaptors 40, 40′, is shown.

A like adaptor 40″ can be used on one or both of the frame 22 and holding part 26. The adaptor 40″ has a U-shaped wall 28″ with a base part 188 and like spaced, depending legs 190. Each leg 190 has an inverted “T” shape with the stem of the “T” offset to define oppositely projecting shorter and longer cross bar parts 191, 192, respectively.

By tilting the wall 28″ relative to aligned slots 194 in the frame 22 or holding part 26, as shown in FIG. 22, the longer part 192 of each leg 190 can be advanced into its respective slot 194 adequately that the shorter part 191 can be tipped down to clear an edge 196 bounding the slot 194. Once the shorter part 191 is passed through the slot 194, the wall 28″ can be shifted from left to right in FIG. 23 so that the slot edge moves into a notch 200 on the wall 28″.

The FIG. 23 position will be maintained by a case 12 in the display position that urges the adaptor 40″ in the left-to-right direction in FIG. 23. In the FIG. 23 position, the wall 28″ cannot be drawn away from its respective frame 22 or holding part 26.

Thus, through a simple manipulation of the wall 28″, the adaptor 40″ can be simply connected to and disconnected from its respective frame 22 and holding part 28. This facilitates interchangeable use of different adaptors 40 that can be kept on hand to accommodate different case configurations.

In this form, the adaptor 40″, in the operative position shown in FIG. 23, performs the function of the aforementioned walls 28 and thus the adaptor 40″ can be considered, for purpose of terminology herein, to be an adaptor and a form of the wall 28.

The invention is also directed to a method of displaying a wearable device as shown in flow diagram form in FIG. 24.

As shown at block 210, a first wearable device is obtained having a first case containing operating components and a first band configured to extend at least partially around a limb of a user to maintain the first wearable device operatively supported on the user's limb.

As shown at block 212, a security assembly is obtained having a frame and a holding part. The security assembly is configured to be changeable between first and second states.

As shown at block 214, the frame is placed on a main support.

As shown at block 216, with the security assembly in the first state, the case is placed against the frame and moved so that a first part of the case moves within a first receptacle on the frame to place the case in a display position.

As shown at block 218, the holding part is changed from a first position into a second position to thereby change the security assembly from the first state into the second state and cause a second part of the case to be moved within a second receptacle on the holding part.

With the method performed in this manner, the first case is captively held between the frame and the holding part with the case in the display position and the holding part in the second position.

A further aspect of the invention is shown in flow diagram form in FIG. 25.

As shown at block 220, the first wearable device is separated from the security assembly.

As shown at block 222, the security assembly is modified to accommodate a second wearable device with a case having a different configuration than the case on the first wearable device.

As shown at block 224, the second wearable device is mounted and secured in substantially the same manner as the first wearable device is mounted and secured.

The foregoing disclosure of specific embodiments is intended to be illustrative of the broad concepts comprehended by the invention.

1. In combination:
a) a first wearable device comprising a first case containing operating components and a first band connected to the case and configured to extend at least partially around a limb of a user to maintain the first wearable device operatively supported on the user's limb; and
b) a security assembly on which the first wearable device can be displayed and confined in movement away from a main support, the security assembly comprising a frame on which the first case can be placed in a display position,
the security assembly configured to be changeable between first and second states,
the security assembly in the first state configured to allow the first case to be selectively moved: i) from a first position spaced from the frame consistently into the display position; and ii) from the display position away from the frame,
the security assembly in the second state configured to prevent the first case in the display position from being separated from the security assembly.

2. The combination according to claim 1 wherein the security assembly comprises spaced first and second receptacles into which spaced first and second parts of the first case project with the first case in the display position and the security assembly in the second state.

3. The combination according to claim 2 wherein with the security assembly in the second state, the first and second receptacles open towards each other.

4. The combination according to claim 2 wherein the security assembly comprises a holding part that is movable between first and second positions, wherein one of the first and second receptacles is defined at least partially on the holding part, the security assembly changed from the first state into the second state as an incident of the holding part moving from the first position into the second position.

5. The combination according to claim 4 wherein the first receptacle is defined at least partially by a first wall on the frame.

6. The combination according to claim 5 wherein the second receptacle is defined at least partially by a second wall on the holding part.

7. The combination according to claim 6 wherein at least one of the first and second walls has one opening in communication with a respective wall receptacle through which a part of the first band projecting away from the first case extends with the first case in the display position and the security assembly in the second state.

8. The combination according to claim 7 wherein the holding part is pivotable relative to the frame around a first axis in moving between the first and second positions for the holding part.

9. The combination according to claim 8 wherein the holding part is spring biased towards the first position for the holding part.

10. The combination according to claim 7 wherein the first wearable device is a chargeable device, the frame comprises a support surface against which the first case abuts with the first case in the display position, an opening is defined through the support surface, and further in combination with a charger for the chargeable device that is supported on the frame, exposed through the support surface opening, and operable to charge the first wearable device with the first case in the display position.

11. The combination according to claim 10 wherein the frame comprises a pedestal that is configured to be fixed to the main support whereupon the support surface is maintained in an elevated position above the main support.

12. The combination according to claim 11 wherein the charger has a power cord that is directed through the pedestal.

13. The combination according to claim 8 wherein there is a component on the frame that cooperates with a component on the holding part to releasably maintain the holding part in the second position.

14. The combination according to claim 13 wherein the component on one of the frame and holding part comprises a post and the component on the other of the frame and holding part comprises a receptacle for the post, the post projecting into the receptacle to thereby maintain the holding part in the second position.

15. The combination according to claim 14 wherein the security assembly further comprises a lock that is changeable between locked and unlocked states, the lock in the locked state preventing the post from being withdrawn from the receptacle, the lock in the unlocked state allowing the post to be withdrawn from the receptacle.

16. The combination according to claim 15 in combination with an actuator that is separate from the lock and usable to change the lock from the locked state into the unlocked state.

17. The combination according to claim 8 wherein the frame has a first edge facing in one axial direction with respect to the first axis and the holding part has a first edge facing oppositely to the one axial direction and in confronting relationship with the first edge on the frame with the holding part in the second position.

18. The combination according to claim 17 wherein the frame has a second edge and the holding part has a second edge, the second edge on the holding part and the second edge on the frame facing axially oppositely with respect to the first axis and are in confronting relationship with the holding part in the second position.

19. The combination according to claim 6 wherein the receptacle defined at least partially by one of the first and second walls has a first configuration and the security assembly further comprises a first adaptor that is usable in conjunction with the one of the first and second walls to change the first receptacle configuration to a second receptacle configuration.

20. The combination according to claim 19 wherein the first adaptor is configured to be placeable in an operative position to change the receptacle defined at least partially by the one of the first and second walls from the first receptacle configuration to the second receptacle configuration and with the first adaptor in the operative position and the first case in the display position the first adaptor is blocked in the operative position.

21. The combination according to claim 20 in combination with a second wearable device comprising a second case containing operating components and a second band configured to extend at least partially around a limb of a user to maintain the second wearable device operatively supported on the user's limb, the second case having a configuration different than a configuration of the first case, the receptacle defined at least partially by the one of the first and second walls with the first configuration adapted to receive a part of the first case, the receptacle defined at least partially by the one of the first and second walls with the second configuration adapted to receive a part of the second case.

22. The combination according to claim 21 wherein the first and second wearable devices each is a smartphone.

23. The combination according to claim 11 wherein the frame comprises a mounting base that is fixed to the pedestal and configured to be placed against and fixed relative to a flat surface on the main support.

24. The combination according to claim 23 in combination with the main support with the flat surface against which the mounting base is fixed.

25. The combination according to claim 24 wherein the charger has a power cord, the pedestal has a peripheral surface through which the power cord for the charger extends to allow access to the power cord above the flat surface of the main support.

26. The combination according to claim 23 wherein the charger has a power cord that is directed through the pedestal and the flat surface on the main support.

27. A method of displaying a wearable device, the method comprising the steps of:
obtaining a first wearable device comprising a first case containing operating components and a first band configured to extend at least partially around a limb of a user to maintain the first wearable device operatively supported on the user's limb;
obtaining a security assembly comprising a frame and a holding part,
the security assembly configured to be changeable between first and second states;
placing the frame on a main support;
with the security assembly in the first state, placing the case against the frame and causing a first part of the case to move within a first receptacle on the frame whereupon the case is in a display position on the frame; and
changing the holding part from a first position into a second position to thereby change the security assembly from the first state into the second state and cause a second part of the case to be moved within a second receptacle on the holding part,
the first case captively held between the frame and the holding part with the first case in the display position and the holding part in the second position.

28. The method of displaying a wearable device according to claim 27 wherein the holding part is pivoted relative to the frame in moving between the first and second positions for the holding part.

29. The method of displaying a wearable device according to claim 27 further comprising the step of directing a first part of the first band extending away from the first case through a fully surrounded first opening on one of the frame and the holding part.

30. The method of displaying a wearable device according to claim 27 further comprising the step of directing a second part of the first band extending away from the first case through a fully surrounded second opening on the other of the frame and the holding part.

31. The method of displaying a wearable device according to claim 27 wherein the first wearable device is a chargeable wearable device and further comprising the step of placing a charger on the frame so that with the first case in the display position the charger is operable to charge the first wearable device.

32. The method of displaying a wearable device according to claim 27 further comprising the steps of obtaining an adaptor, and placing the adaptor in an operative position on one of the frame and holding part to change the receptacle on the one of the frame and holding part from a first configuration to a different second configuration.

33. The method of displaying a wearable device according to claim 32 further comprising the steps of: a) obtaining a second wearable device comprising a second case containing operating components and a second band configured to extend at least partially around a limb of a user to maintain the second wearable device operatively supported on the user's limb, the second case having a configuration different than a configuration of the first case; and b) with the adaptor in the operative position and the case in the display position changing the holding part from the first position into the second position.

34. The method of displaying a wearable device according to claim 27 further comprising the step of releasably locking the holding part in the second position.

35. The method of displaying a wearable device according to claim 27 wherein the frame comprises a pedestal and further comprising the step of fixing the pedestal to a surface on the main support so that the first case in the display position is spaced above the surface on the main support.

36. The method of displaying a wearable device according to claim 35 wherein the first wearable device is a chargeable device and further comprising the step of placing a charger on the frame so that with the first case in the display position the charger is operable to charge the wearable device.

37. The method of displaying a wearable device according to claim 36 further comprising the step of directing a power cable for the charger through the pedestal.

38. The method of displaying a wearable device according to claim 36 further comprising the step of directing a power cord for the charger from the charger into the pedestal.

39. The method of displaying a wearable device according to claim 36 further comprising the step of directing a power cord for the charger from the charger into the pedestal and through a peripheral wall of the pedestal above the surface on the main support.

40. The method of displaying a wearable device according to claim 36 further comprising the step of directing a power cord for the charger from the charger through the pedestal and through the surface of the main support.
